(19) United States
(12) Patent Application Publication
(10) Pub. No.: US 2004/0156374 A1
(43) Pub. Date: Aug. 12, 2004

(54) Router and routing method for providing linkage with mobile nodes

(75) Inventors: Bak-Gu Lee, Suwon-si (KR); Kyoung-Hwan Moon, Suwon-si (KR); Pyung-Soo Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/705,947

(22) Filed: Nov. 13, 2003

(30) Foreign Application Priority Data
Feb. 9, 2003 (KR) 2003-10412

(51) Int. Cl. H04L 12/28

(52) U.S. Cl. 370/401

(57) ABSTRACT

A router and a routing method for providing linkage with mobile nodes are provided. The router exchanges a packet between a mobile node and correspondent nodes, by performing authentication for purposes of security, binding update, and packet conversion, etc. The router and the routing method allow the mobile node to directly communicate with correspondent nodes that do not include functions for communicating with the mobile node.

This application claims the priority of Korean Patent Application No. 2003-10412, filed on Feb. 19, 2003, in the Korean Intellectual Property Office, the disclosure of which is incorporated herein in its entirety by reference.

### BACKGROUND OF THE INVENTION

1. Field of the Invention

The present invention relates to a router and a routing method for providing linkage with mobile nodes, and more particularly, to a router and a routing method for allowing a mobile node to communicate with correspondent nodes that do not include functions for communicating with a mobile node.

2. Description of the Related Art

To improve the existing Internet Protocol Version 4 (IPv4), Internet Protocol Version 6 (IPv6) has been developed. IPv6 is also referred to as the “IP Next Generation” protocol.

The greatest characteristic of IPv6 is that the length of the IP address has increased from 32 bits to 128 bits. This IP address extension is provided in response to the depletion of network addresses due to the explosive development of the Internet.

IPv6 can designate mechanisms for source authentication of a packet, the guarantee of data integrity, secret security, etc., by extending the header area of the packet.

Also, a mobile IPv6 has been developed which provides functions for allowing mobile nodes, such as portable computers, to communicate with each other using IPv6.

The mobile IPv6 allows a mobile node having a home address provided in a home link area to communicate with a desired correspondent node, using a Care of Address (CoA), which is provided in a foreign link area, even in a case where the mobile node moves from the home link area to the foreign link area.

Detailed descriptions related to the mobile IPv6 are disclosed in “Mobility Support in IPv6” (draft_ietf-mobileip-ipv6-20.txt), Internet Engineering Task Force (IETF).

However, to establish communication between the mobile node with the mobile IPv6 functions and the correspondent nodes, the correspondent nodes must also have the mobile IPv6 functions.

More specifically, the mobile IPv6 performs authentication for security purposes between the mobile node and the correspondent nodes and then performs binding of the mobile node and the correspondent nodes. Thereafter, the mobile node can directly communicate with the correspondent nodes, using the Care of Address (CoA), not via a home agent in the home link area. Therefore, it is needed that the correspondent nodes have authentication functions for security and functions required for binding to directly communicate with the mobile node.

However, a problem exists in that the time and cost required for providing the mobile IPv6 functions to all correspondent nodes are great.

### SUMMARY OF THE INVENTION

The present invention provides a router and a routing method for allowing a mobile node having mobile functions for mobile communication to communicate with correspondent nodes not having the mobile functions.

According to an aspect of the present invention, there is provided a router for transmitting a packet between a mobile node in a foreign link area and correspondent nodes, the router including: a data storage unit, which stores data for generating an authentication key generation token; a first interface, which receives and transmits a packet to a destination address stored in a header of the packet; a packet monitoring unit, which outputs an authentication request packet requiring authentication of the mobile node if the packet transmitted from the first interface is the authentication request packet; and a controller, which receives a packet from the packet monitoring unit, generates an authentication key generation token with reference to data for generating an authentication key generation token and the data stored in the data storage unit, generates an authentication key using the authentication key generation token, stores the authentication key generation token and the authentication key in the data storage unit, and outputs the authentication key generation token to the first interface, wherein the first interface receives and transmits the authentication key generation token to the mobile node.

It is preferable that if the packet received from the first interface is a binding update packet encoded using the authentication key generated by the mobile node according to the authentication key generation token, the packet monitoring unit outputs the binding update packet to the controller, and the controller extracts binding information, including a home address of the mobile node and a foreign address of the mobile node provided in a foreign link area, from the binding update packet using the authentication key stored in the data storage unit, and stores the extracted binding information in the data storage unit.

It is preferable that the router further comprises a packet converter, which receives a packet output from the packet monitoring unit, and converts a source address of the packet from the foreign address of the mobile node to the home address of the mobile node and outputs the converted address, according to a control given by the controller; and a second interface, which receives the packet output from the packet converter, and transmits the packet to a correspondent node, according to an address of the correspondent node stored in the header of the packet, wherein the packet monitoring unit searches for the header of the packet received from the first interface, extracts and outputs binding information included in the packet header to the controller, and outputs the packet to the packet converter, and the controller controls the packet converter, so that the packet converter converts the source address of the packet into the home address of the mobile node and outputs the converted address, if the binding information exists in the data storage unit.

It is preferable that the controller controls the packet converter, so that the packet converter passes the packet without converting the source address included in the packet, if the binding information does not exist in the data storage unit.

It is preferable that the second interface receives and outputs a packet transmitted by the correspondent node to the packet monitoring unit, the packet monitoring unit outputs the destination address stored in the header of the packet received through the second interface, to the controller, and outputs a packet received from the packet converter, the controller controls the packet converter, so that the packet converter converts the destination address of the packet into a foreign address of the mobile node, if the destination address is the home address of the mobile node and the home address is bound with the foreign address of the mobile node, and the packet converter converts the destination address stored in the header of the packet transmitted by the correspondent node into the foreign address of the mobile node, according to a control given by the controller, and outputs the converted packet to the first interface.

According to another aspect of the present invention, there is provided a routing method of transmitting a packet between a mobile node in a foreign link area and correspondent nodes, the method comprising: (a) monitoring whether a packet transmitted from the mobile node is an authentication request packet requiring authentication of the mobile node; (b) generating an authentication key generation token, with reference to pre-stored data for generating the authentication key generation token, if the packet transmitted from the mobile node is the authentication request packet requiring authentication of the mobile node; (c) generating an authentication key using the authentication key generation token and storing the authentication key and the authentication key generation token; and (d) transmitting the authentication key generation token to the mobile node.

It is preferable that the routing method includes: (e) receiving a binding update packet authenticated using the authentication key, the authentication key generated by the mobile node according to the authentication key generation token; and (f) extracting and storing binding information including a home address of the mobile node and a foreign address of the mobile node provided in the foreign link area, from the binding update packet, using the authentication key.

It is preferable that the routing method further comprises: (g) receiving a packet transmitted by the mobile node, the packet including the binding information and data; (h) checking whether the same binding information as the binding information included in the packet transmitted by the mobile node exists in the stored binding information; (i) converting the source address of the packet from the foreign address of the mobile node into the home address of the mobile node, if the same binding information as the binding information included in the packet transmitted by the mobile node exists in the stored binding information; and (j) transmitting the converted packet to the correspondent node.

It is preferable that the routing method further comprises: (k) transmitting the packet itself to the correspondent node without converting the source address thereof, if the same binding information as the binding information included in the packet transmitted by the mobile node does not exist in the stored binding information.

It is preferable that the routing method further comprises: (1) extracting a home address of the mobile node stored as a destination address in the header of the packet transmitted from the correspondent node; (m) searching for the stored binding information and extracting a foreign address of the mobile node bound with the home address of the mobile node; (n) converting the destination address of the header of the packet transmitted by the correspondent node into the foreign address of the mobile node; and (o) transmitting the packet transmitted by the correspondent node to the mobile node, according to the foreign address of the correspondent node.

### BRIEF DESCRIPTION OF THE DRAWINGS

The above and other features and advantages of the present invention will become more apparent by describing in detail exemplary embodiments thereof with reference to the attached drawings in which:

FIG. 1 shows a communication system including a router for establishing communication between a mobile node and correspondent nodes, according to an embodiment of the present invention;

FIG. 2 is a flow chart illustrating a process for updating binding information in a home agent, according to an embodiment of the present invention;

FIG. 3 is a view for explaining encapsulation and decapsulation, according to an embodiment of the present invention;

FIG. 4 is a block diagram of a router, according to an embodiment of the present invention;

FIG. 5 is a flow chart illustrating an authentication process for security performed by the router, according to an embodiment of the present invention;

FIG. 6 is a view for describing a case where the mobile node transmits two authentication request packets;

FIG. 7 shows an example of an authentication table;

FIG. 8 is a flow chart illustrating a process for updating binding information in the router, according to an embodiment of the present invention;

FIG. 9 shows an example of a binding cache;

FIG. 10 is a flow chart illustrating a process in which the router processes packets transmitted to the correspondent node by the mobile node, after updating the binding information, according to an embodiment of the present invention;

FIG. 11 shows an example of a neighbor cache in a data storage unit;

FIG. 12 is a view for explaining an example in which a packet converter converts a source address of a packet;

FIG. 13 is a flow chart illustrating a process in which a router processes a packet transmitted by the correspondent node, according to an embodiment of the present invention; and

FIG. 14 is a view for explaining an example in which the packet converter converts a destination address of a packet.

### DETAILED DESCRIPTION OF THE INVENTION

Hereinafter, embodiments of the present invention will be described in detail with reference to the appended drawings.

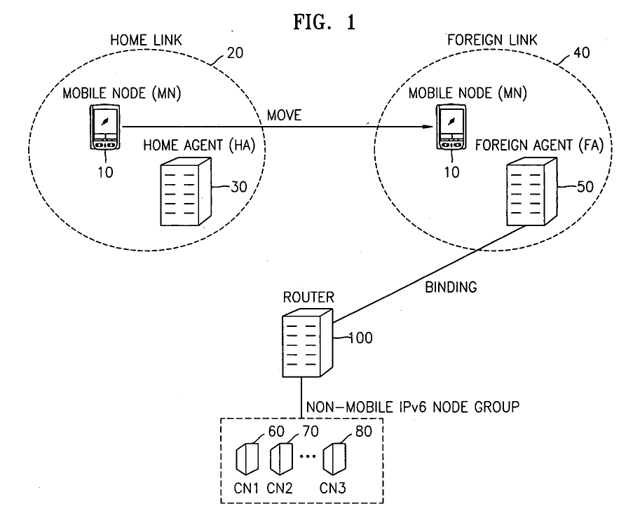

FIG. 1 shows a communication system including a router 100 for allowing a mobile node 10 to communicate with correspondent nodes 60 through 80, according to an embodiment of the present invention.

The mobile node 10 is a portable apparatus including the mobile Internet Protocol version 6 (IPv6) functions. The mobile node 10 may be a portable computer, a Personal Digital Assistant (PDA), and the like.

A home agent 30 is a router located in a home link area 20. A home address of the mobile node 10 is registered in this router.

The correspondent nodes CN1 60, CN2 70, and CN3 80 are nodes without the mobile IPv6 functions and with the general IPv6 functions. The correspondent nodes can be mobile nodes or non-mobile nodes. For example, a correspondent node can be a File Transfer Protocol (FTP) server, a Hyper Text Transfer Protocol (HTTP) server, a Simple Mail Transfer Protocol (SMTP) server, and the like.

In a case where the mobile node 10 located in the home link area 20 moves to a foreign link area 40, it is necessary to update binding information for binding the home address and a care of address (CoA) of the mobile node 10 in the home agent 30, in order to establish communication between the mobile node 10 and one of the correspondent nodes 60 through 80, via the router 100.

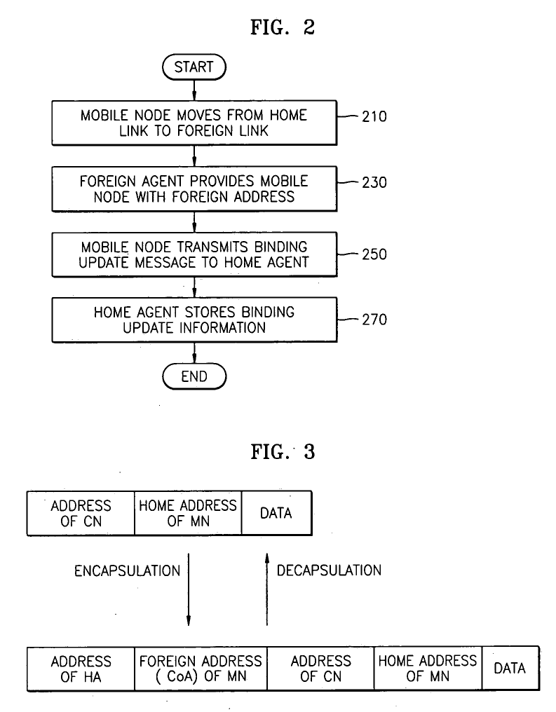

FIG. 2 is a flow chart illustrating the process for updating the binding information in the home agent 30, according to an embodiment of the present invention;

Referring to FIGS. 1 and 2, the process for updating the binding information in the home agent 30 is described below.

The mobile node 10 located in the home link area 20 is moved to the foreign link area 40 by a user of the mobile node 10 (step 210).

A foreign agent 50 recognizes that the mobile node 10 has entered the foreign link area 40 and provides the mobile node 10 with a Care of Address (CoA) (step 230).

The mobile node 10 receiving the CoA transmits a binding update message to the home agent 30 (step 250). The binding update message includes a header, a source address, of which is the CoA, and a destination address, of which is an address of the home agent 30.

The home agent 30 that received the binding update message including the CoA of the mobile node 10 binds and stores the home address of the mobile node 10 and the CoA (step 270). Accordingly, although the mobile node 10 moves to the foreign link area, the home agent 30 can transfer a packet transmitted from the correspondent nodes to the mobile node 10 in the foreign link area using the stored binding information.

After the binding information of the mobile node 10 is updated in the home agent 30, one of the correspondent nodes 60 through 80, i.e., CN1 60 first transmits a packet to the mobile node 10. Since CN1 60 learns only the home address of the mobile node 10, the destination address stored in the header of the packet transmitted by the CN1 60 is the home address of the mobile node 10. If the home agent 30 receives the packet, transmitted by the CN1 60, the home agent 30 encapsulates the packet, with reference to the pre-stored binding information of the mobile node 10, and transmits the resulting packet to the mobile node 10 in the foreign link area.

FIG. 3 is a view for explaining encapsulation by the home agent 30 and decapsulation by the mobile node 10, according to an embodiment of the present invention.

If the home agent 30 receives the packet, which is transmitted by the CN1 60, and the destination address of which is the home address of the mobile node 10, the home agent 30 searches for the binding information to find a foreign address of the mobile node 10. Then, the home agent 30 performs a process of encapsulation that adds the searched foreign address to the packet, as shown in FIG. 3, and transmits the encapsulated packet to the mobile node 10 in the foreign link area.

The mobile node 10 in the foreign link area receiving the encapsulated packet decapsulates the packet. Thus, the original packet transmitted from the CN1 60 can be transferred to the upper layer.

The mobile node 10 which received the packet transmitted from the CN1 60 performs an authentication process and a binding update process for security purposes with the router 100, and then transmits the actual data to the CN1 60 via the router 100.

Hereinafter, the operations of the router 100 will be described with reference to the appended drawings.

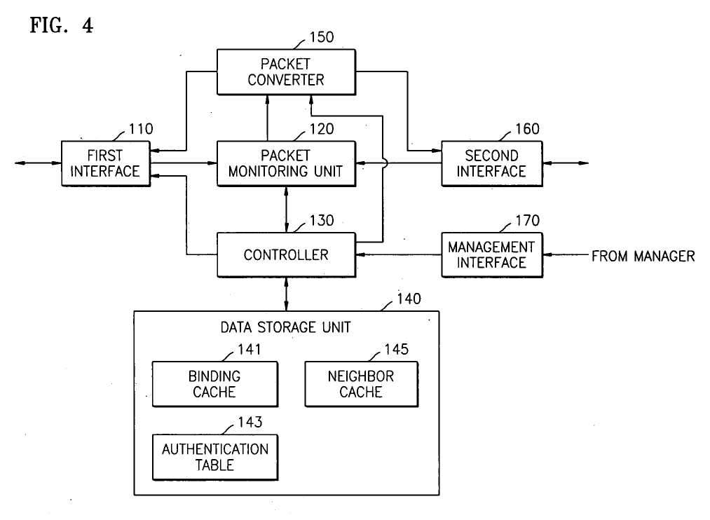

FIG. 4 is a block diagram of the router 100, according to an embodiment of the present invention.

Referring to FIG. 4, the router 100 comprises a first interface 110, a packet monitoring unit 120, a controller 130, a data storage unit 140, a packet converter 150, a second interface 160, and a manager interface 170.

The first interface 110 receives/transmits a packet from/to the home agent 30 or the mobile node 10, via a mobile IPv6 network (not shown).

The second interface 160 receives/transmits a packet from/to the CN1 60.

The packet monitoring unit 120 monitors the packet transmitted from the home agent 30 or the mobile node 10 and received through the first interface 110, or the packet transmitted through the CN1 60 and received through the second interface 160, to provide desired information to the controller 130 according to the type of received packet, or transmits the received packet to the packet converter 150, according to a control of the controller 130.

If the controller 130 receives the packet or the desired information from the packet monitoring unit 120, the controller 130 controls the packet monitoring unit 120 and the packet converter 150, with reference to data stored in the data storage unit 140, to thereby control an authentication process, a binding update process, data transmission operations, etc.

The data storage unit 140 includes a binding cache 141, an authentication table 143, and a neighbor cache 145, and stores binding update information, data related to authentication for security, and the IP addresses of the correspondent nodes 60 through 80 connected to the router 100, respectively.

The packet converter 150 converts a source address or destination address included in the header of the packet received from the packet monitoring unit 120, according to a control of the controller 130, and outputs the converted packet.

A manager inputs the IP addresses of the correspondent nodes through the manager interface 170, so that the router 106, rather than the correspondent nodes without the mobile IPv6 functions can perform the mobile IPv6 functions. If the IP addresses of the correspondent nodes are received through the manager interface 170, the controller 130 allocates data storage areas corresponding to the respective correspondent nodes to the binding cache 141 and the authentication table 143 of the data storage unit 140.

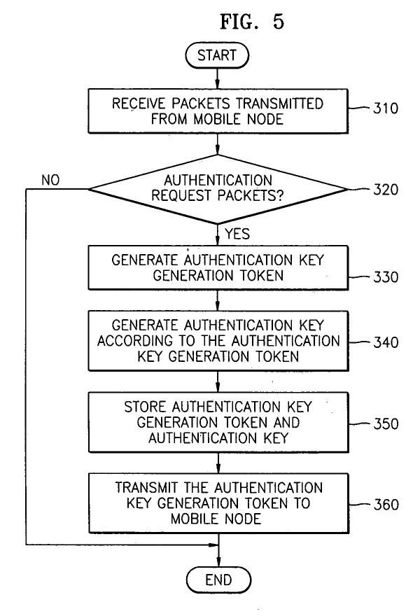

FIG. 5 is a flow chart illustrating the authentication process for security performed by the router, according to an embodiment of the present invention.

Hereinafter, the authentication process for security performed by the router 100 will be described with reference to FIGS. 4 and 5.

As described above, the mobile node 10 moves to the foreign link area 40, receives a foreign address from the foreign agent 50, updates the binding information in the home agent 30, and then receives the original packet transmitted from the CN1 60.

The mobile node 10 receives the original packet transmitted by the CN1 60 from the home agent 30, and generates and transmits an authentication request packet including the address of the CN1 60 as its destination address. The router 100 receives the authentication request packet (step 310). As defined in the mobile IPv6, the mobile node 10 generates and transmits two authentication request packets.

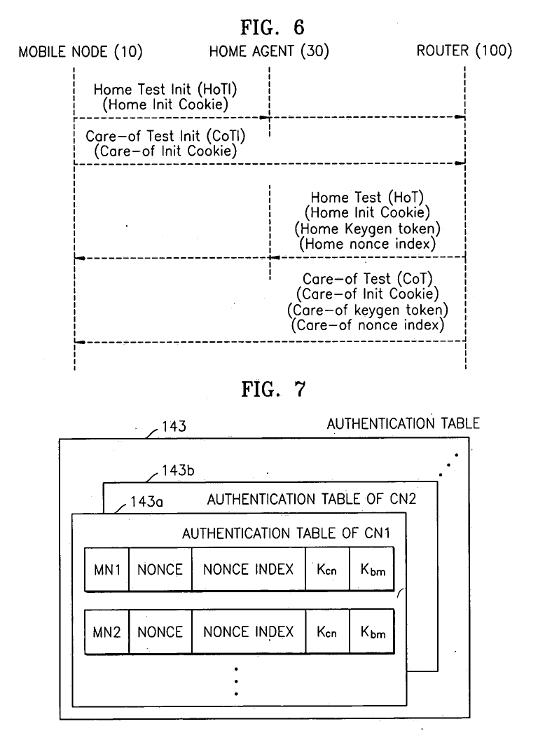

FIG. 6 is a view for explaining a case where the mobile node transmits two authentication request packets.

Referring to FIG. 6, the mobile node 10 generates and transmits two authentication request packets: Home Test Init (HOTI) and Care-of-Test Init (CoTI). HoTI is transmitted to the router 100 via the home agent 30, and CoTI is directly transmitted to the router 100.

The HoTI and CoTI are input to the packet monitoring unit 120 through the first interface 110 of the router 100.

The packet monitoring unit 120 determines whether the input packets are authentication request packets (step 320).

If one of the input packets is an authentication request packet, the packet monitoring unit 120 outputs the input packet to the controller 130. The controller 130 searches for the authentication table 143a of the CN1 60, among the authentication tables related to a plurality of correspondent nodes stored in the data storage unit 140. The controller 130 reads, for example, NONCE and Kcn as data for authentication related to the mobile node 10, among data related to a plurality of mobile nodes stored in the authentication table 143a of CN1 60. NONCE is a random number used for generating a Home Keygen Token and a Care-of Keygen Token as authentication key generation tokens. The NONCE is periodically generated by a random number generator (not shown) and stored in the authentication table 143a of the CN1 60. Kcn is also a value used for generating the Home Keygen Token and Care-of Keygen Token as the authentication key generation tokens.

The controller 130 generates the authentication key generation tokens, i.e., Home Keygen Token and Care-of Keygen Token, using the NONCE and Kcn, and the home address and foreign address of the mobile node 10 included in the HoTI and CoTI, according to the following Equations 1 and 2 (step 330).

Home Keygen Token=First(64, HMAC_{—}SHA1(Kcn, (home address|nonce|0))) (1)

Care-of Keygen Token=First(64, HMAC_{—}SHA1(Kcn, (care-of address|nonce|6))) (2)

Here, the HMAc_SHA1 function is a type of Hash function. The First(64, HMAC_SHA1) function has as an output value, the first 64 bits among bits generated by the HMAC_SHA1 function.

After generating the authentication key generation tokens, the Home Keygen Token and Care-of Keygen Token, the controller 130 generates an authentication key Kbm using the authentication key generation tokens, according to the following Equation 3 (step 340).

Kbm=SHA1(Home Keygen Token|care-of Keygen Token) (3)

Detailed descriptions for the Home Keygen Token and the Care-of Keygen Token as the authentication key generation tokens are disclosed in “Mobility Support in IPv6” (draft-ietf-mobileip-ipv6-20.txt), the Internet Engineering Task Force (IETF) for the mobile IPv6.

The controller 130 stores the generated authentication key Kbm and the authentication generation tokens in the authentication table 143 of the data storage unit 140 (step 350).

FIG. 7 shows an example of the authentication table 143. The authentication table 143 includes authentication tables 143a and 143b for the respective correspondent nodes. The authentication tables for the respective correspondent nodes stores data for authenticating a plurality of mobile nodes communicating with the respective correspondent nodes. It is assumed that the mobile node 10 is MN1 in the authentication table 143a of FIG. 7, according to an embodiment of the present invention. The authentication key Kbm generated for authentication of the mobile node 10 is stored in the authentication table 143a, together with NONCE, NONCE INDEX, and Kcn to be used for generating the authentication key generation tokens.

The controller 130 generates and transmits a HoT and a CoT message to the mobile node 10, in response to the received HoTI and CoTI, respectively (step 360). As shown in FIG. 6, the HoT message is transmitted to the mobile node 10 via the home agent 30, and the CoT message is directly transmitted to the mobile node 10. The source addresses of the headers of the Hot message and the CoT message are not the address of the router 100 but an IP address of a correspondent node MN1 with which the mobile node 10 wishes to directly communicate.

The HoT message and the CoT message include the Home Keygen Token and the Care-of Keygen Token, respectively, and commonly include NONCE INDEX. The NONCE INDEX is an INDEX indicating how NONCE is used for generating the Home Keygen Token and the Care-of Keygen Token. By transmitting the NONCE INDEX, it is unnecessary to transmit NONCE itself. The router 100 can communicate with the mobile node 10, using both the home address and the foreign address CoA of the mobile node 10, by successfully transmitting the HoT message and the CoT message to the mobile node 10.

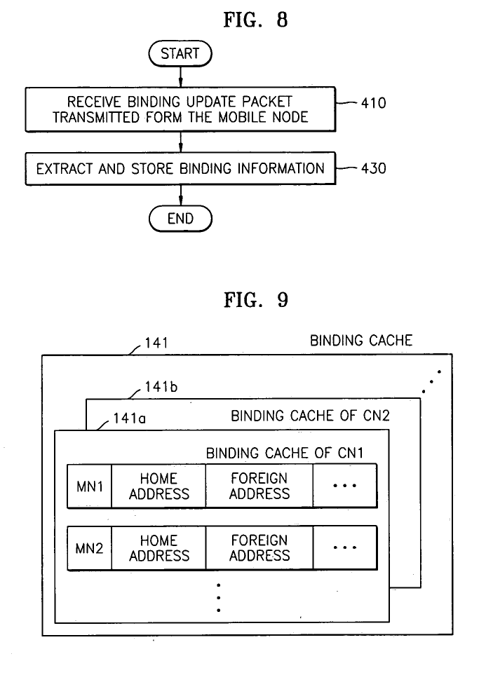

FIG. 8 is a flow chart illustrating the process for updating the binding information in the router 100, according to an embodiment of the present invention.

Referring to FIG. 8, the mobile node 10 generates the same authentication key with the authentication key Kbm stored in the router 100, using the Home Keygen Token and the Care-of Keygen Token included in the HoT message and the CoT message transmitted from the router 100, according to Equation 3 shown in numbered paragraph 79. The mobile node 10 generates and transmits a Binding Update (BU) packet including the CoA of the mobile node 10, using the generated authentication key Kbm. The source address included in the header of the binding update packet is the home address of the mobile node 10 and the destination address included in the header thereof is the address of the CN1.

The router 100 receives the binding update packet through the first interface 110 (step 410).

The packet monitoring unit 120 which has received the binding update packet through the first interface 110 recognizes the binding update packet and transfers the packet to the controller 130.

The controller 130 searches for the authentication table, authenticates the binding update packet, using the authentication key Kbm provided to the CN1, and then stores the foreign address of the mobile node 10 included in the binding update packet with the home address of the mobile node 10 in the data storage unit 140 (step 430).

FIG. 9 shows an example of the binding cache. Referring to FIG. 9, the binding cache 141 includes binding caches 141a and 141b for respective correspondent nodes. The binding caches 141a and 141b for the respective correspondent nodes store binding information related to a plurality of mobile nodes to communicate with the respective correspondent nodes.

After the router 100 stores the binding information of the mobile node 10 in the MN1 entry in the binding cache 141a of the CN1, the router 100 transmits to the mobile node 10 a binding acknowledgement message indicating binding update completion. When the binding update has failed, the router 100 writes a predetermined value indicating binding update failure in a state field included in the binding acknowledge message and transmits the binding acknowledge message. In the case of binding update failure, like the conventional technique, the mobile node 10 and the CN1 60 respectively, perform encapsulation and decapsulation of the packet via the home agent 30, to thereby exchange packets.

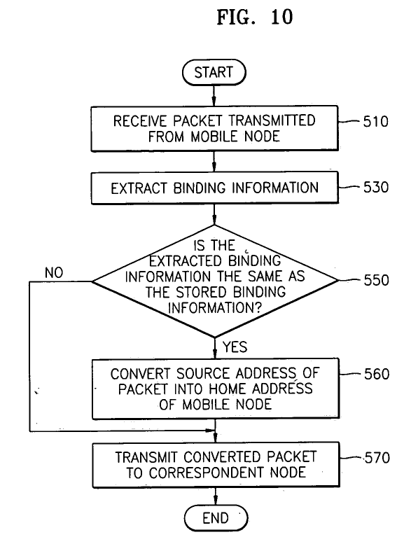

FIG. 10 is a flow chart illustrating a process in which the router 100 processes the packets transmitted to the correspondent node MN1 via the mobile node 10, after updating the binding information, according to an embodiment of the present invention.

Referring to FIG. 10, the first interface 110 receives the packet transmitted by the mobile node 10 (step 510).

If the packet monitoring unit 120 receives the packet transmitted by the mobile node 10 through the first interface 110, the packet monitoring unit 120 searches for the header of the received packet, and extracts and outputs binding information included in the header to the controller 130 (step 530). Also, the packet monitoring unit 120 outputs the received packet to the packet converter 150.

The binding information includes the foreign address of the mobile node 10 stored in the source address area, the address of MN1 stored in the destination address area, and the home address of the mobile node 10 stored in the option area, among data stored in the packet header.

The controller 130 searches for the binding cache 141a of the CN1 60 in the binding cache 141 and determines whether the received binding information, i.e., the foreign address and the home address of the mobile node 10, exist in the binding cache 141a of the CN1 60 (step 550).

If the foreign address and home address of the mobile node 10 exist in the binding cache 141a of the CN1 60, the controller 130 controls the packet converter 150 so that the packet converter 150 converts the source address of the header of the received packet from the foreign address of the mobile node 10 to the home address of the mobile node 10.

That is, the packet converter 150 converts the source address of the header of the packet received from the packet monitoring unit 120, into the home address of the mobile node 10, according to a control given by the controller 130 (step 560).

FIG. 12 shows a view for explaining an example in which the packet converter 150 converts the source address of the packet.

In FIG. 12, the left portion shows a packet header before being converted by the packet converter, wherein the source address is the foreign address of the mobile node 10, the destination address is the address of CN1 60, and the option area stores the home address of the mobile node 10.

The right portion shows the packet header after being converted by the packet converter, wherein the source address is the home address of the mobile node 10 and the option area is removed.

The packet converter 150 outputs the converted packet to the second interface 160. The second interface 160 transmits the packet to the CN1 60 (step 570). Meanwhile, if it is determined that the binding information input to the controller 130 does not exist in the binding cache 141 in step 550, the packet converter 150 outputs the packet without converting the home address of the packet, so that the packet is transmitted to the corresponding address.

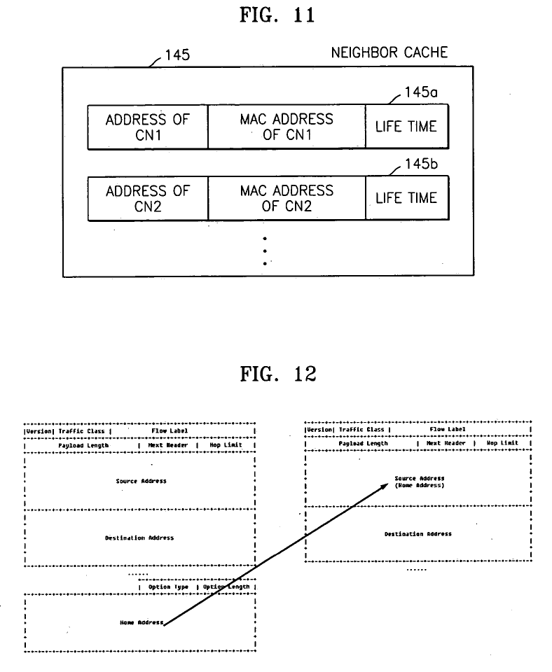

FIG. 11 shows an example of a neighbor cache 145 in the data storage unit 140. Referring to FIG. 11, the neighbor cache 145 consists of entries for correspondent nodes. Each entry includes a data field such as an address for each correspondent node, a Medium Access Control (MAC) address, a life time indicating the validity of an address, etc.

The router 100 transmits the converted packet to the CN1 60, according to the address of the CN1 60 stored in the neighbor cache 145 and the MAC address.

The CN1 60 can receive the packet transmitted by the mobile node 10 located in the foreign link area, although the CN1 60 cannot perform the mobile IPv6 functions such as authentication for security, binding update, and packet conversion, since the CN1 60 receives the packet storing as its source address the home address of the mobile node 10.

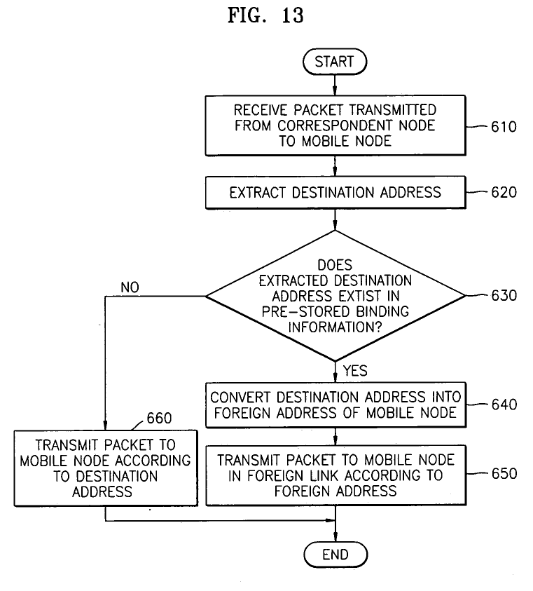

FIG. 13 is a flow chart illustrating a process in which the router processes the packet transmitted by the correspondent node, according to an embodiment of the present invention.

According to the process illustrated in FIG. 10, the CN1 60 that has received a packet from the router 100 transmits a packet storing as its destination address the home address of the mobile node 10. The packet transmitted by the CN1 60 is input to the router 100 through the second interface 160 (step 610).

The packet monitoring unit 120 receives the packet transmitted from the CN1 60 through the second interface 160, searches for the header of the received packet, and extracts and outputs the destination address stored in the packet header to the controller 130 (step 620). In this embodiment, the destination address is the home address of the mobile node 10. Also, the packet monitoring unit 120 outputs the received packet to the packet converter 150.

The controller 130 searches for the binding cache 141a of the CN1 in the binding cache 141, and determines whether the received destination address, i.e., the home address of the mobile node 10, is bound with the foreign address of the mobile node 10 (step 630).

If the home address of the mobile node 10 is bound with the foreign address of the mobile node 10 in the binding cache 141, the controller 130 controls the packet converter 150 so that the packet converter 150 converts the destination address of the header of the received packet into the foreign address of the mobile node 10.

That is, the packet converter 150 converts the destination address of the header of the packet received from the packet monitoring unit 120, from the home address of the mobile node 10 to the foreign address, according to a control given by the controller 130 (step 640).

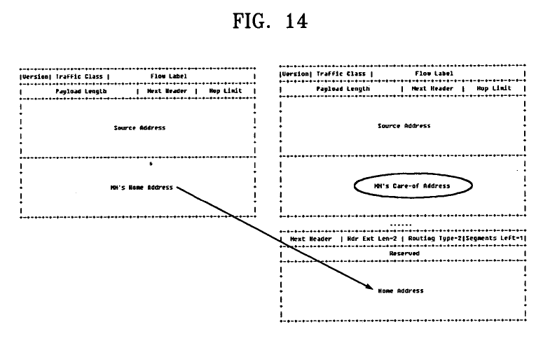

FIG. 14 is a view for explaining an example in which the packet converter 150 converts the destination address of the packet. In FIG. 14, the left portion shows a packet header before being converted by the packet converter 150, wherein the destination address area stores the home address of the mobile node 10 and the source address area stores the address of the CN1 60.

The right portion shows a packet header after being converted by the packet converter 150, wherein the destination address is the foreign address of the mobile node 10. The home address of the mobile node 10 as an original destination address of the packet is stored with a form of Type2 Routing Header in the header.

The packet converter 150 outputs the converted packet to the first interface 110. The first interface 110 transmits the received packet to the mobile node 10, according to the foreign address of the mobile node 10 stored as a destination address of the converted header (step 650).

If it is determined that the destination address of the received packet is not bound with a desired foreign address and is not pre-stored in the binding cache 141 in step 630, the controller 130 controls the packet converter 150 so that the packet converter 150 does not convert the destination address. The packet converter 150 outputs the received packet itself to the first interface 110 and the first interface 110 transmits the packet to the destination address of the packet (step 660).

The present invention may be embodied as a program stored on a computer readable medium that can be run on a general computer. Here, the computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet). The present invention may also be embodied as a computer readable program code unit stored on a computer readable medium, for causing a number of computer systems connected via a network to incorporate distributed processing.

As described above, the router and the routing method for providing linkage with mobile nodes, according to the present invention, allows the mobile nodes to directly communicate with correspondent nodes that do not include functions for communicating with the mobile nodes.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A router for transmitting a packet between a mobile node in a foreign link area and correspondent nodes, the router comprising:
a data storage unit, which stores data for generating an authentication key generation token;
a first interface, which receives and transmits a packet to a destination address stored in a header of the packet;
a packet monitoring unit, which outputs an authentication request packet requiring authentication of the mobile node if the packet transmitted from the first interface is the authentication request packet; and
a controller, which receives a packet from the packet monitoring unit, generates an authentication key generation token with reference to the data for generating an authentication key generation token stored in the data storage unit, generates an authentication key using the authentication key generation token, stores the authentication key generation token and the authentication key in the data storage unit, and outputs the authentication key generation token to the first interface;
wherein the first interface receives and transmits the authentication key generation token to the mobile node.

2. The router of claim 1, wherein if the packet received from the first interface is a binding update packet encoded using the authentication key generated by the mobile node according to the authentication key generation token, the packet monitoring unit outputs the binding update packet to the controller, and
the controller extracts binding information, including a home address of the mobile node and a foreign address of the mobile node provided in a foreign link area, from the binding update packet using the authentication key stored in the data storage unit, and stores the extracted binding information in the data storage unit.

3. The router of claim 2, further comprising:
a packet converter, which receives a packet output from the packet monitoring unit, and converts a source address of the packet from the foreign address of the mobile node to the home address of the mobile node and outputs the converted address, according to a control given by the controller; and
a second interface, which receives the packet output from the packet converter, and transmits the packet to a correspondent node, according to an address of the correspondent node stored in the header of the packet,
wherein the packet monitoring unit searches for the header of the packet received from the first interface, extracts and outputs binding information included in the packet header to the controller, and outputs the packet to the packet converter, and
the controller controls the packet converter, so that the packet converter converts the source address of the packet into the home address of the mobile node and outputs the converted address, if the binding information exists in the data storage unit.

4. The router of claim 3, wherein the controller controls the packet converter, so that the packet converter passes the packet without converting the source address included in the packet, if the binding information does not exist in the data storage unit.

5. The router of claim 3, wherein the second interface receives and outputs a packet transmitted by the correspondent node to the packet monitoring unit,
the packet monitoring unit outputs the destination address stored in the header of the packet received through the second interface, to the controller, and outputs a packet received from the packet converter,
the controller controls the packet converter, so that the packet converter converts the destination address of the packet into a foreign address of the mobile node, if the destination address is the home address of the mobile node and the home address is bound with the foreign address of the mobile node, and
the packet converter converts the destination address stored in the header of the packet transmitted by the correspondent node into the foreign address of the mobile node, according to a control given by the controller, and outputs the converted packet to the first interface.

6. A routing method of transmitting a packet between a mobile node in a foreign link area and correspondent nodes, the method comprising:
(a) monitoring whether a packet transmitted from the mobile node is an authentication request packet requiring authentication of the mobile node;
(b) generating an authentication key generation token, with reference to pre-stored data for generating the authentication key generation token, if the packet transmitted from the mobile node is the authentication request packet requiring authentication of the mobile node;
(c) generating an authentication key using the authentication key generation token and storing the authentication key and the authentication key generation token; and
(d) transmitting the authentication key generation token to the mobile node.

7. The routing method of claim 6, further comprising:
(e) receiving a binding update packet authenticated using the authentication key, the authentication key generated by the mobile node according to the authentication key generation token; and
(f) extracting and storing binding information comprising a home address of the mobile node and a foreign address of the mobile node provided in the foreign link area, from the binding update packet, using the authentication key.

8. The routing method of claim 7, further comprising:
(g) receiving a packet transmitted by the mobile node, the packet including the binding information and data;
(h) checking whether the same binding information as the binding information included in the packet transmitted by the mobile node exists in the stored binding information;
(i) converting the source address of the packet from the foreign address of the mobile node into the home address of the mobile node, if the same binding information as the binding information included in the packet transmitted by the mobile node exists in the stored binding information; and
(j) transmitting the converted packet to the correspondent node.

9. The routing method of claim 8, further comprising:
(k) transmitting the packet itself to the correspondent node without converting the source address thereof, if the same binding information as the binding information included in the packet transmitted by the mobile node does not exist in the stored binding information.

10. The routing method of claim 8, further comprising:
(l) extracting a home address of the mobile node stored as a destination address in the header of the packet transmitted from the correspondent node;
(m) searching for the stored binding information and extracting a foreign address of the mobile node bound with the home address of the mobile node;
(n) converting the destination address of the header of the packet transmitted by the correspondent node into the foreign address of the mobile node; and
(o) transmitting the packet transmitted by the correspondent node to the mobile node, according to the foreign address of the correspondent node.

11. A computer readable medium having embodied thereon a computer program for a routing method of transmitting a packet between a mobile node in a foreign link area and correspondent nodes, the method comprising:
(a) monitoring whether a packet transmitted from the mobile node is an authentication request packet requiring authentication of the mobile node;
(b) generating an authentication key generation token, with reference to pre-stored data for generating the authentication key generation token, if the packet transmitted from the mobile node is the authentication request packet requiring the authentication of the mobile node;
(c) generating an authentication key according to the authentication key generation token and storing the authentication key and the authentication key generation token; and
(d) transmitting the authentication key generation token to the mobile node.
